(19) United States
(12) Patent Application Publication
(10) Pub. No.: US 2011/0307700 A1
(43) Pub. Date: Dec. 15, 2011

(54) SYSTEM AND METHOD FOR PERFORMING TWO FACTOR AUTHENTICATION AND DIGITAL SIGNING

(76) Inventor: Erik Wahlstr+e,uml o+ee m, Stockholm (SE)

(21) Appl. No.: 12/956,265

(22) Filed: Nov. 30, 2010

(30) Foreign Application Priority Data
Jun. 14, 2010 (SE) 1050605-3

(51) Int. Cl. H04L 9/00

(52) U.S. Cl. 713/176; 726/3

(57) ABSTRACT

The present invention relates to a system (10) operable to perform two factor authentication. The system (10) comprises a browser means (12), a server means (14) connected to the browser means (12), and a memory means (16) connected to the browser means (12). The server means (14) is operable to receive a first factor from a user means (18), and to thereafter automatically send a two factor challenge to the browser means (12). The browser means (12) is in turn operable to automatically retrieve an encrypted secret from the memory means (16), and to automatically decrypt the secret. The two factor authentication is based on the challenge and the decrypted secret.

### FIELD OF THE INVENTION

The present invention relates in a first aspect to a system operable to perform two factor authentication.

According to a second aspect the present invention relates to a method for performing two factor authentication.

According to a third aspect the present invention relates to a system operable to perform digital signing.

According to a fourth aspect the present invention relates to a method for performing digital signing.

According to a fifth aspect the present invention relates to at least one computer program product for performing two factor authentication or digital is signing.

### BACKGROUND OF THE INVENTION

The patent document US 2009/0006861 A1 relates to secure access to a web page using a personal pass-phrase to prevent phishing attacks. Upon requesting a web page from a user device, a determination is made as to whether or not an encrypted cookie exists for the requested web page. An encrypted cookie includes the personal pass-phrase and at least one of an identifier of the user device, an identifier of a web browser from which the web page request is initiated, and information about the network path used to establish the personal pass-phrase. If an encrypted cookie does not exist, the user is provided a capability to create the encrypted cookie including a personal pass-phrase. If the encrypted cookie exists, the user device provides the encrypted cookie with the web page request for use by the web server to validate the web page request using information included in the encrypted cookie. If the web page request is valid, the web server propagates the web page toward the user device, otherwise the user device receives an indication that the web server is invalid. This solution has a number of disadvantages. It is not a two factor authentication. It cannot be changed every time, and it cannot work as an automatic authentication, and a two factor authentication where the user must supply both factors by hand. The cookie in question can be copied by anyone.

The patent document WO 2007/015253 A2 relates to a method, system and computer-readable code for providing authentication services. In some embodiments, an attempt is made to match an IP address associated with a service and/or authentication request and user details of the request with an ISP account. In exemplary embodiments, if there is an indication that the IP address was issued by an ISP to a user matching the user details, the user is authenticated. In exemplary embodiments, a database of allowable dynamic and/or static IPs is maintained, and users are authenticated in accordance with contents of the maintained database. A disadvantage with this solution is that it is really easy to set your own IP address so it is not a two factor authentication at all.

The patent document US 2009/0138950 A1 relates to a computerized method of providing access to a secure resource. The method includes, to each of is a plurality of authorized users, providing a link to the secure resource. Each link includes a unique password embedded therein and each unique password relates to a particular user identification (userlD) and personal identification number (PIN). The method also includes receiving a request to access the resource using a linkl having a password embedded therein, which request originates at a web browser. The method further includes directing the browser to a login screen and receiving via the login screen a userlD and PIN. The method also includes determining whether the userlD and PIN relate to one another and to the password and allowing or denying access to the resource in accordance with the determination. A disadvantage with this solution is that it is not a two factor authentication method at all.

The patent document US 2007/0130473 A1 relates to a system for authenticating a user that requires a physical token associated with the user to be connected with a particular device associated with the user. A disadvantage with this solution is that the URL is open to everyone, as e. g. people listening to the traffic or people using the same computer as the user. It is also stored in the browsers history.

The patent document US 2009/0260077 A1 relates to a security-enhanced login technique that provides a convenient and easy-to-use two factor technique to enhance the security of passwords without requiring any changes on the server side of a client-server network. The technique employs a convenient and easy-to-use two factor technique to generate strong passwords for Web and other applications. In this technique, a convenient or personal device such as a mouse is used as the other factor besides a user password. A secret stored in the mouse or other personal device is hashed together with the password entered by a user and the server ID, to generate a strong, server-specific password which is used to authenticate the user to the server. This password enhancement operation is carried out inside the personal device. A disadvantage with this solution is that a user still has to have an alternative hardware that they must bring along. It is not in the browser and always with them.

The above mentioned solutions suffer from a lot of problems. Today users need to know what a two factor authentication is before they can use it. They also need to understand the concepts of a seed, a challenge and a response.

The manual work of typing a challenge on the token, and then the result to the requestor of the authentication/signing. This is a problem that many of the existing authentication and signing methods have.

If using certificates they have to be delivered by an administrator, and then imported and protected into the computer by the end user.

A hardware token can be lost and needs to be replaced before the user is able to login again.

The current hardware and software solutions are hard and expensive to deploy. If an error occurs it takes months to push out a correction.

Sometimes a cell phone is used as a token and an SMS message is sent to the cell phone of the user. SMS are expensive to send and sometimes it will be received to the cell phone a long time after it was sent due to network latencies.

Sometimes a synchronized number is used and every time the user uses the token that number is changed. The same change is done on the server side. This is called synchronized authentication. A serious problem with this method is that the number on the token and on the server can come out of sync. The authentication method will not work at all and a new seed must be manually planted in the token to login again or the number on the token and on the server has to be re-synced. The re-sync needs to be done by an administrator.

In order to always be able to login, the users need to always bring the hardware token with them all the time.

The current software tokens cannot be installed using really thin clients.

The software tokens need to be developed to all different types of clients.

In known two factor authentication methods it is common to use a challenge and responses. The challenges are used together with a shared secret. A response is calculated using the challenge and the secret. When using this known method the user needs to understand the concept of a seed, a challenge and a response. It is also an error prone method due to all the user steps needed for a successful authentication.

### SUMMARY OF THE INVENTION

The above mentioned problems are solved with a system operable to perform two factor authentication according to Claim 1. The system comprises a browser means, a server means connected to the browser means, and a memory means connected to the browser means. The server means is operable to receive a first factor from a user means, and thereafter to automatically send a two factor challenge to the browser means. The browser means is thereafter operable to automatically retrieve an encrypted secret from the memory means, and to automatically decrypt the secret. The two factor authentication is based on the challenge and the decrypted secret.

A main advantage with this solution is that a user does not need to know that he/she is using two factor authentication. Another advantage is that user interaction is only required in one step, everything else is done automatically for the user.

A further advantage in this context is achieved if the browser means also is operable to automatically calculate a response based on the challenge and the decrypted secret, and to automatically send the response to the server means, which in turn is operable to automatically authenticate the user if the response is a match, and to automatically reject the authentication if the response does not match.

Furthermore, it is an advantage in this context if the response does not match, the server means is operable to delete the secret.

A further advantage in this context is achieved if, when the secret have been deleted, or when none exists, the system is operable to store a new secret in the memory means.

Furthermore, it is an advantage in this context if the memory means is in the form of a local, permanent memory means in the browser means.

A further advantage in this context is achieved if the secret is encrypted by using information from the browser means, device specific information, and username and password, or other information only known by the user.

The above mentioned problems are also solved with a method for performing two factor authentication according to Claim 7. The method is performed with the aid of a system comprising a browser means, a server means connected to the browser means, and a memory means connected to the browser means. The method comprises the steps:

with the aid of the server means, to receive a first factor from a user means;
with the aid of the server means, to automatically send a two factor challenge to the browser means;
with the aid of the browser means, to automatically retrieve an encrypted secret from the memory means;
with the aid of the browser means, to automatically decrypt the secret; and
to automatically perform two factor authentication based on the challenge and the decrypted secret.

A main advantage with this solution is that a user does not need to know that he/she is using two factor authentication. Another advantage is that user interaction is only required in one step, everything else is done automatically for the user.

A further advantage in this context is achieved if the method also comprises the steps:

with the aid of the browser means, to automatically calculate a response based on the challenge and the decrypted secret;
with the aid of the browser means, to automatically send the response to the server means; and
with the aid of the server means, to automatically authenticate the user if the response is a match; or to automatically reject the authentication if the response does not match.

Furthermore, it is an advantage in this context if the method also comprises the step:

if the response does not match, with the aid of the server means, to delete the secret:

A further advantage in this context is achieved if the method also comprises the step:

with the aid of the system, to store a new secret in the memory means, when the secret have been deleted, or when none exists.

Furthermore, it is an advantage in this context if the memory means is in the form of a local, permanent memory means in the browser means.

A further advantage in this context is achieved if the secret is encrypted by using information from the browser means, device specific information, and username and password, or other information only known by the user.

The above mentioned problems are solved with a system operable to perform digital signing according to Claim 13. The system comprises a browser means, a server means connected to the browser means, and a memory means connected to the browser means. The server means is operable to automatically send a signing challenge to the browser means. Thereafter, the browser means is operable to automatically retrieve an encrypted secret from the memory means, and to automatically decrypt the secret. The digital signing is based on the signing challenge and the decrypted secret.

A main advantage with this solution is that a user does not need to know that he/she has digitally signed something. Another advantage is that user interaction is only required in one step, everything else is done automatically for the user.

A further advantage in this context is achieved if the browser means also is operable to receive a security PIN code from a user means, to automatically calculate a signing response based on the signing challenge, the security PIN code, and the decrypted secret, and to automatically send the signing response to the server means, where after the server means is operable to automatically perform digital signing, if the signing response is a match, or to automatically reject the digital signing if the signing response does not match.

According to another embodiment it is an advantage if the server means also is operable to first receive something the user knows from a user means, and then to sign digitally.

Furthermore, it is an advantage in this context if the browser means also is operable to automatically calculate a signing response based on the signing challenge and the decrypted secret, and to automatically send the signing response to the server means, which in turn is operable to automatically perform the digital signing, if the signing response is a match, or to automatically reject the digital signing if the signing response does not match.

A further advantage in this context is achieved if, if the signing response does not match, the server means is operable to delete the secret.

Furthermore, it is an advantage in this context if, when the secret have to been deleted, or when none exists, the system is operable to store a new secret in the memory means.

A further advantage in this context is achieved if the memory means is in the form of a local, permanent memory means in the browser means.

Furthermore, it is an advantage in this context if the secret is encrypted by using information from the browser means, device specific information, and username and password, or other information only known by the user.

The above mentioned problems are also solved with a method for performing digital signing according to Claim 21. The method is performed with the aid of a system comprising a browser means, a server means connected to the browser means, and a memory means connected to the browser means. The method comprises the steps:

with the aid of the server means, to automatically send a signing challenge to the browser means;
with the aid of the browser means, to automatically retrieve an encrypted secret from the memory means;
with the aid of the browser means, to automatically decrypt the secret; and
to automatically perform digital signing based on the signing challenge and the decrypted secret.

A main advantage with this solution is that a user does not need to know that he/she has digitally signed something. Another advantage is that user interaction is only required in one step, everything else is done automatically for the user.

A further advantage in this context is achieved if the method also comprises the steps:

with the aid of the browser means, to receive a security PIN code from a user means;
with the aid of the browser means, to automatically calculate a signing response based on the signing challenge, the security PIN code, and the decrypted secret;
with the aid of the browser means, to automatically send the signing response to the server means; and
with the aid of the server means, to automatically perform digital signing, if the signing response is a match; or to automatically reject the digital signing if the signing response does not match.

According to another embodiment it is an advantage if the method also comprises the step:

with the aid of the server means, to first receive something the user knows from a user means, and then to sign digitally.

Furthermore, it is an advantage in this context if the method also comprises the steps:

with the aid of the browser means, to automatically calculate a signing response based on the signing challenge and the decrypted secret;
with the aid of the browser means, to automatically send the signing response to the server means; and
with the aid of the server means, to automatically perform digital signing, if the signing response is a match; or to automatically reject the digital signing if the signing response does not match.

A further advantage in this context is achieved if the method also comprises the step:

if the signing response does not match, with the aid of the server means, to delete the secret.

Furthermore, it is an advantage in this context if the method also comprises the step:

with the aid of the system, to store a new secret in the memory means, when the secret have been deleted, or when none exists.

A further advantage in this context is achieved if the memory means is in the form of a local, permanent memory means in the browser means.

Furthermore, it is an advantage in this context if the secret is encrypted by using information from the browser means, device specific information, and username and password, or other information only known by the user.

The above mentioned problems are also solved with at least one computer program product according to Claim 29. The at least one computer program product is/are directly loadable into the internal memory of at least one digital computer, and comprises software code portions for performing the steps of Claim 7 or Claim 21 when the at least one product is/are run on the at least one computer.

A main advantage with this solution is that a user does not need to know that he/she is using two factor authentication or digital signing. Another advantage is that user interaction is only required in one step, everything else is done automatically for the user.

It will be noted that the term “comprises/comprising” as used in this description is intended to denote the presence of a given characteristic, step or component, without excluding the presence of one or more other characteristic, features, integers, steps, components or groups thereof.

Embodiments of the invention will now be described with a reference to the accompanying drawings, in which:

### BRIEF DESCRIPTION OF THE DRAWINGS

FIG. 1 is a block diagram of a system operable to perform two factor authentication according to the present invention;

FIG. 2 is a flow chart of a method for performing two factor authentication according to the present invention;

FIG. 3 is a flow chart in more detail of the method disclosed in FIG. 2;

FIG. 4 is a block diagram of a system operable to perform digital signing according to the present invention;

FIG. 5 is a flow chart of a method for performing digital signing according to the present invention;

FIG. 6 is a flow chart in more detail of a first embodiment of the method disclosed in FIG. 5;

FIG. 7 is a flow chart in more detail of a second embodiment of the method disclosed in FIG. 5; and

FIG. 8 schematically shows a number of computer program products according to the present invention.

### DETAILED DESCRIPTION OF THE PREFERRED EMBODIMENTS

First of all follows a list of some words used, at least partly, in the following description.

Hardware token—Something the user has. A physical gadget that is used for two factor authentication or digital signing.
Software token—A software application that is used as the something you have in two factor authentication or digital signing.
Token—A hardware or software token.
Seed—A shared secret that both, for example, the server and the token knows.

### Secret—Seed.

Challenge—For example a server generates a challenge, which might be a random number. The challenge and the seed are then used in the something the user has to calculate a response that is sent to the server. The server knows the challenge and the secret seed values and verifies that it matches.
Response—Sent to, for example, the server from the end user. A response is a value calculated using the challenge and the seed in the something the user has.

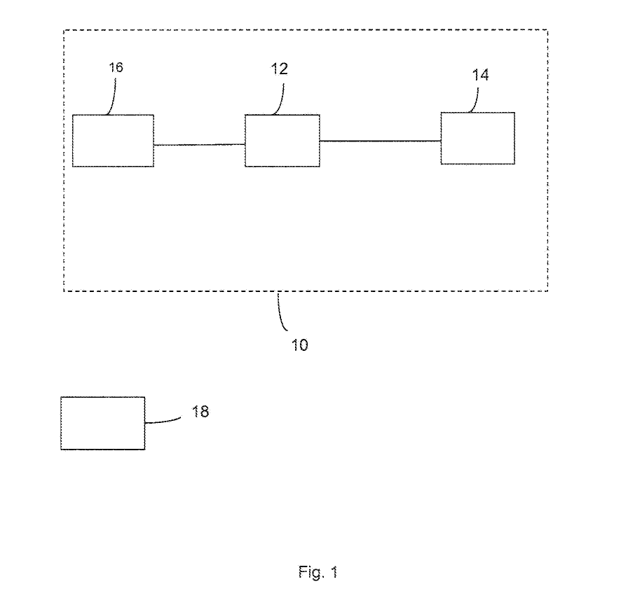

In FIG. 1 there is disclosed a block diagram of a system 10 operable to perform two factor authentication according to the present invention. The system 10 comprises a browser means 12, a server means 14 connected to the browser means 12, and a memory means 16 also connected to the browser means 12. Furthermore, in FIG. 1 there is also disclosed a user means 18. It is pointed out that the user means 18 both be included or not included in the system 10. It is pointed out that the user means 18 also can be a computer program. The server means 14 is operable to receive a first factor from the user means 18, and thereafter to automatically send a two factor challenge to the browser means 12. The browser means 12 is in turn operable to automatically retrieve an encrypted secret from the memory means 16. Thereafter, the browser means 12 is operable to decrypt the secret. The two factor authentication is based on the challenge and the decrypted secret.

According to a preferred embodiment of the system 10, the browser means 12 is also operable to automatically calculate a response based on the challenge and the decrypted secret, and to automatically send the response to the server means 14. The server means 14 is in turn operable to automatically authenticate the user if the response is a match, or to automatically reject the authentication if the response does not match.

Furthermore, according to another embodiment, the server means 14 is operable to delete the secret if the response does not match. When the secret have been deleted, or when none exists, the system 10 is operable to store a new secret in the memory means 16.

According to one preferred alternative, the memory means 16 is in the form of a local, permanent memory means 16 comprised in the browser means 12.

Furthermore, according to yet another preferred alternative, the secret is encrypted by using information from the browser means 12, device specific information, and username and password, or other information only known by the user.

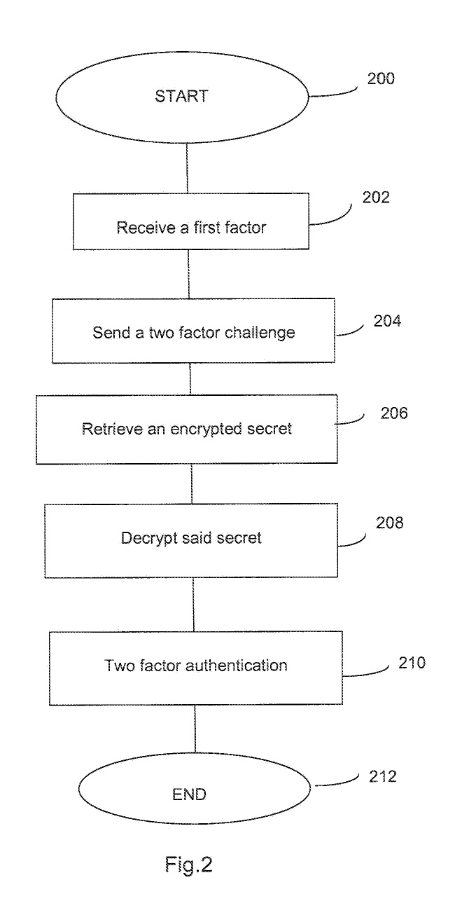

In FIG. 2 there is disclosed a flow chart of a method for performing two factor authentication according to the present invention. The method can e. g., be performed with the aid of a system 10 as disclosed in FIG. 1. The method begins at block 200. Thereafter, the method continues, at block 202, with the step: to receive a first factor from a user means 18 with the aid of the server means 14. The method continues, at block 204, with the step: to automatically send a two factor challenge to the browser means 12 with the aid of the server means 14. Thereafter, the method continues, at block 206, with the step: to automatically retrieve an encrypted secret from the memory means 16 with the aid of the browser means 12. The method continues, at block 208, with the step: to automatically decrypt the secret with the aid of the browser means 12. Thereafter, the method continues, at block 210, with the step: to automatically perform two factor authentication based on the challenge and the decrypted secret. The method is completed at block 212.

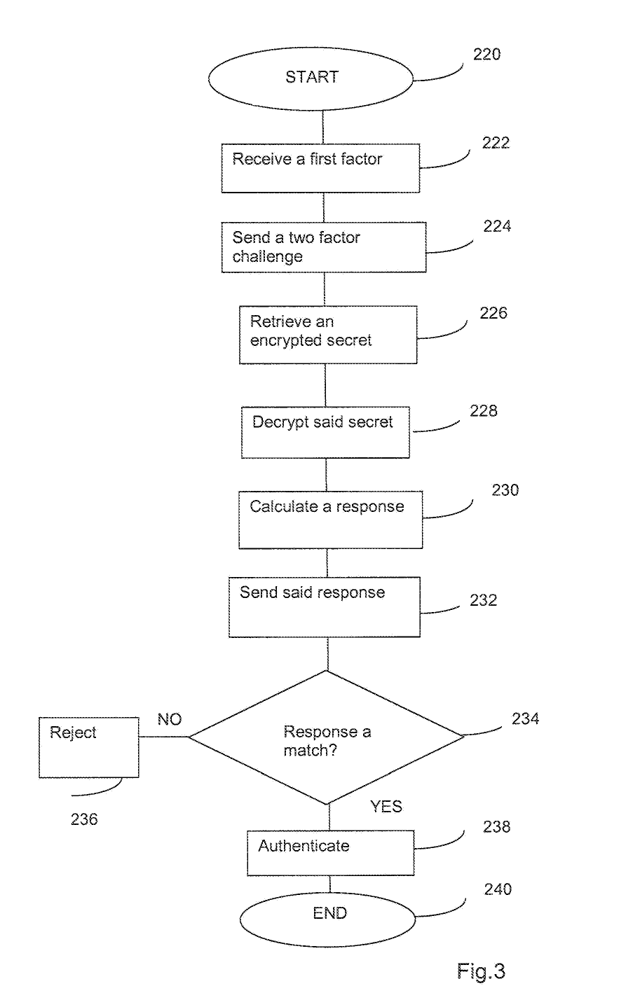

In FIG. 3 there is disclosed a flow chart in more detail of the method disclosed in FIG. 2. For the sake of completeness it is pointed out that even this method can be performed with the aid of the system 10 disclosed in FIG. 1. The method begins at block 220. Thereafter, the method continues, at block 222, with the step: to receive a first factor from a user means 18 with the aid of the server means 14. The method continues, at block 224, with the step: to automatically send a two factor challenge to the browser means 12 with the aid of the server means 14. Thereafter, the method continues, at block 226, with the step: to automatically retrieve an encrypted secret from the memory means 16 with the aid of the browser means 12. Furthermore, the method continues, at block 228, with the step: to automatically decrypt the secret with the aid of the browser means 12. The method continues, at block 230, with the step: to automatically calculate a response based on the challenge and the decrypted secret with the aid of the browser means 12. Thereafter, the method continues, at block 232, with the step: to automatically send the response to the server means 14 with the aid of the browser means 12. The method continues, at block 234, to ask the question: Is the response a match? If the answer is negative, the method continues, at block 236, with the step: to automatically reject the authentication. If, on the other hand, the answer is affirmative, the method continues, at block 238, with the step: to automatically authenticate the user. The method is completed at block 240. is According to a preferred embodiment of the method, it also comprises the step: if the response does not match, to delete the secret with the aid of the server means 14.

Furthermore, according to another embodiment, the method also comprises the step: when the secret have been deleted, or when none exists, to store a new secret in the memory means 16 with the aid of the system 10.

According to one preferred alternative of the method, the memory means 16 is in the form of a local, permanent memory means 16 comprised in the browser means 12.

Furthermore, according to yet another preferred alternative of the method, the secret is encrypted by using information from the browser means 12, device specific information, and username and password from the user means 18.

The invention is used as one of two factors that combined results in the two factor authentication. If a system administrator thinks that a two factor authentication is not needed, the solution according to the present invention can be used as a one factor authentication.

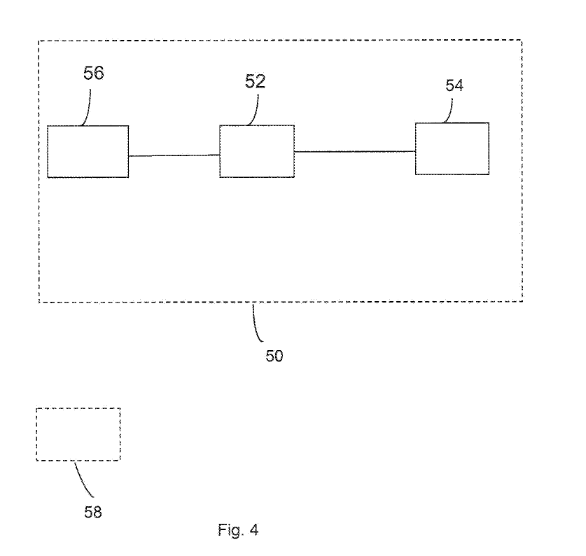

In FIG. 4 there is disclosed a block diagram of a system 50 operable to perform digital signing according to the present invention. The present system 50 comprises a browser means 52, a server means 54 connected to the browser means 52, and a memory means 56 also connected to the browser means 52. Furthermore, in FIG. 4 there is also disclosed a user means 58. The user means 58 is represented with a dashed line, because it does not have to be part of FIG. 4. It can also be omitted. It is pointed out that the user means 58 either can be included or not included in the system 50. It is also pointed out that the user means 58 also can be a computer program. The server means 54 is operable to automatically send a signing challenge to the browser means 52. The browser means 52 is in turn operable to automatically retrieve an encrypted secret from the memory means 56. Thereafter, the browser means 52 is operable to decrypt the secret. The digital signing is based on the signing challenge and the decrypted secret.

According to a first preferred embodiment of the system 50, the browser means 52 is also operable to receive a security PIN code from the user means 58, to automatically calculate a signing response based on the signing challenge, the security PIN code, and the decrypted secret, and to automatically send the signing response to the server means 54. Thereafter, the server means 54 is operable to is automatically perform the digital signing, if the signing response is a match. On the other hand, if the signing response does not match, the server means 54 is operable to automatically reject the digital signing.

According to a second preferred embodiment of the system 50, the server means 54 is also operable to first receive something the user knows from the user means 58. It is pointed out that the something could e. g. be a factor, such as a code means, a link means, or a username and a password. The digital signing is then performed using the signing challenge and the decrypted secret. Furthermore, the browser means 52 is also operable to automatically calculate a signing response based on the signing challenge and the decrypted secret, and to automatically send the signing response to the server means 54. The server means 54 is in turn operable to automatically perform the digital signing, if the signing response is a match. If, on the other hand, the signing response does not match, the server means 54 is operable to automatically reject the digital signing.

According to another embodiment, the server means 54 is operable to delete the secret if the signing response does not match.

Furthermore, according to yet another embodiment, when the secret have been deleted, or when none exists, the system 50 is operable to store a new secret in the memory means 56.

According to one preferred alternative, the memory means 56 is in the form of a local, permanent memory means 56 comprised in the browser means 52.

Preferably, the local memory means 56 is a permanent storage that is both permanent and secure. Saving the secret in for example a cookie is not a secure storage. To be really secure the storage must be protected using the same origin policy and certificates.

Furthermore, according to yet another preferred alternative, the secret is encrypted by using information from the browser means 52, device specific information, and username and password from the user means 58.

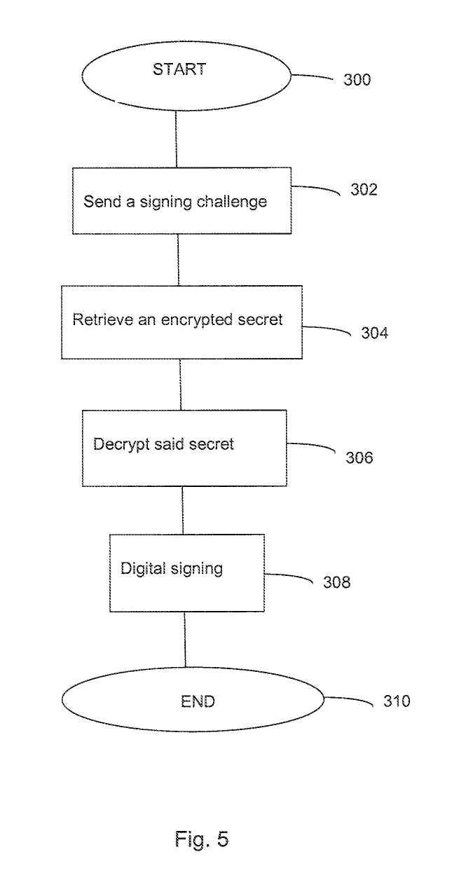

In FIG. 5 there is disclosed a flow chart of a method for performing digital signing according to the present invention. The method can e. g., be performed with the aid of a system 50 disclosed in FIG. 4. The method begins at block 300. Thereafter, the method continues, at block 302, with the step: to automatically send a signing challenge to the browser means 52 with the aid of the server means 54. The method continues, at block 304, with the step: to automatically retrieve an encrypted secret from the memory means 56 with the aid of the browser means 52. Thereafter, the method continues, at block 306, with the step: to automatically decrypt the secret with the aid of the browser means 52. The method continues, at block 308, with the step: to automatically perform digital signing based on the signing challenge and the decrypted secret. The method is completed at block 310.

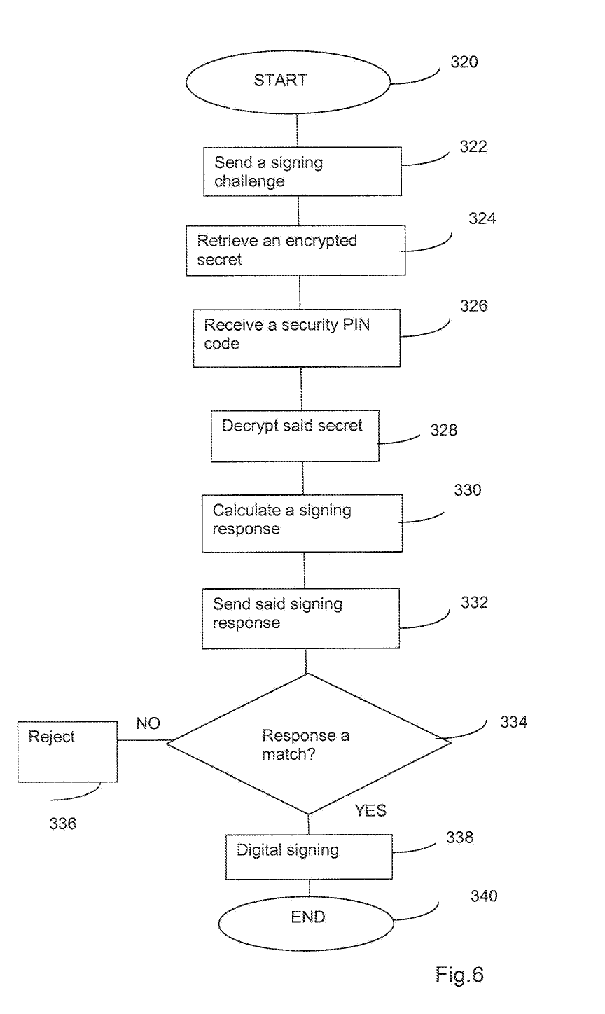

In FIG. 6 there is disclosed a flow chart in more detail of a first embodiment of the method disclosed in FIG. 5. The method begins at block 320. Thereafter, the method continues, at block 322, with the step: to automatically send a signing challenge to the browser means 52 with the aid of the server means 54. The method continues, at block 324, with the step: to automatically retrieve an encrypted secret from the memory means 56 with the aid of the browser means 52. Thereafter, the method continues, at block 326, with the step: to receive a security PIN code from the user means 58 with the aid of the browser means 52. The method continues, at block 328, with the step: to automatically decrypt the secret with the aid of the browser means 52. Thereafter, the method continues, at block 330, with the step: to automatically calculate a signing response based on the signing challenge, the security PIN code, and the decrypted secret with the aid of the browser means 52. The method continues, at block 332, with the step: to automatically send the signing response to the server means 54 with the aid of the browser means 52. Thereafter, the method continues, at block 334, to ask the question: Is the signing response a match? If the answer is negative, the method continues, at block 336, with the step: to automatically reject the digital signing. If, on the other hand, the answer is affirmative, the method continues, at block 338, with the step: to automatically perform digital signing. The method is completed at block 340.

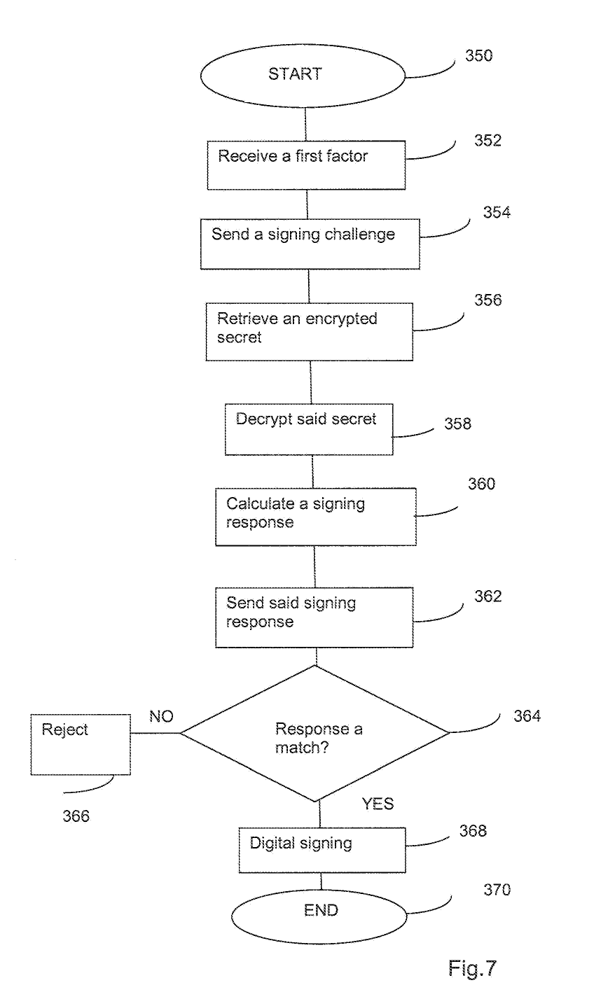

In FIG. 7 there is disclosed a flow chart in more detail of a second embodiment of the method disclosed in FIG. 5. The method begins at block 350. Thereafter, the method continues, at block 352, with the step: to receive a first factor from the user means 58 with the aid of the server means 54. It is pointed out that the first factor in step 352 can be something that the user has logged in with, such as a URL, a code, a username and a password. It could even be a two factor authentication. The method continues, at block 354, with the step: to automatically send a signing challenge to the browser means 52 with the aid of the server means 54. Thereafter, the method continues, at block 356, with the step: to automatically retrieve an encrypted secret from the memory means 56 with the aid of the browser means 52. The method continues, at block 358, with the step: to automatically decrypt the secret with the aid of the browser means 52. Thereafter, the method continues, at block 360, with the step: to automatically calculate a signing response based on the signing challenge and the decrypted secret with the aid of the browser means 52. The method continues, at block 362, with the step: to automatically send the signing response to the server means 54 with the aid of the browser means 52. Thereafter, the method continues, at block 364, to ask the question: Is the signing response a match? If the answer is negative, the method continues, at block 366, with the step: to automatically reject the digital signing. If, on the other hand, the answer is affirmative, the method continues, at block 368, with the step: to automatically perform digital signing. The method is completed at block 370.

According to a preferred embodiment, the method also comprises the step: if the signing response does not match, to delete the secret with the aid of the server means 54.

According to another preferred embodiment, the method also comprises the step: when the secret have been deleted, or when none exists, to store a new secret in the memory means 56 with the aid of the system 50.

Furthermore, according to yet another embodiment, the memory means 56 is in the form of a local, permanent, memory means 56 comprised in the browser means 52.

According to another alternative, the secret is encrypted by using information from the browser means 52, device specific information, and username and password from the user means 58.

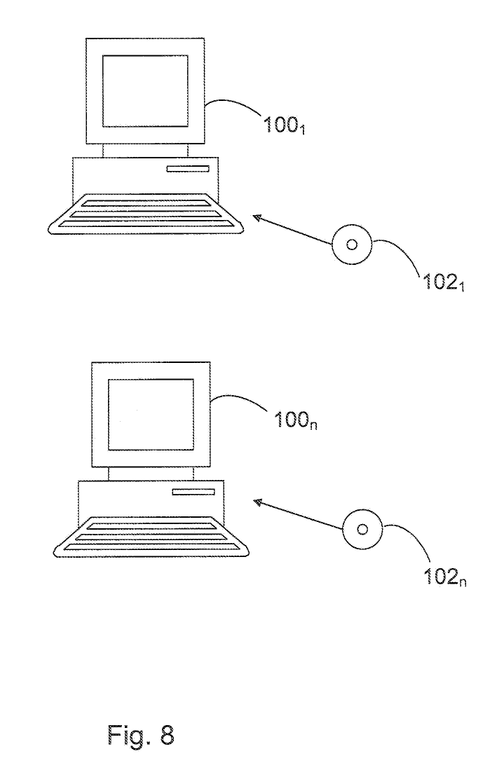

In FIG. 8, some computer program products 102₁ . . . , 102ₙ according to the present invention are schematically shown. In FIG. 8, n different digital computers 100₁, . . . , 100, are shown, wherein n is an integer. In FIG. 8, n different computer program products 102₁, . . . , 102ₙ are shown, here disclosed in the form of CD discs. The different computer program products 102₁, . . . , 102ₙ are directly is loadable into the internal memory of the n different computers 100₁, . . . , 100ₙ. Each computer program product 102₁, . . . , 102ₙ comprises software code portions for performing all the steps according to Claim 7 or Claim 21, when the product/products 102₁, . . . , 102ₙ is/are run on the computers 100₁, . . . , 100ₙ. The computer program products 102₁, . . . , 102ₙ may, for instance, be in the form of diskettes, RAM discs, magnetic tapes, magneto-optical discs or some other suitable products. Furthermore, the computer program products 102₁, . . . , 102ₙ may also be in the form of a file which is digitally distributed, e. g. it can be put on the server means and distributed to the browser means over the Internet.

The device specific information can e. g. be all possible information that we can gather from the browser. For example, operating system and precise version number of the browser. For example, operating system and precise version number of the browser, what the browser plug-ins that is installed, time zone, screen size and color depth and fonts. It is also possible to get the IP number of the client (where the browser is installed) from the server.

Instead of the use of username and password, we can use any knowledge, or combination of more pieces of knowledge, that the user have. It could be a PIN code. Furthermore, it could be an URL to a web page that only the user knows. It could also be described as another factor in two factor authentication.

The above mentioned system and method for digital signing can be used together with a value that the user wants to sign to visualize the value to the user. The value to sign could also be a part of the signing challenge.

The above described systems and methods have all or in part, the following advantages listed below.

A full two factor authentication and a digital signing is done every time a user wants it but the user do not need to do anything to get it.

The users do not need to know they are using two factor authentication.

Some of the current solutions according to the prior art uses SMS messages to send a password valid one time. When using the present solution the users do not have to wait for and read an SMS message. There is also no cost for the server provider to send SMS messages every time a user want to log-in.

The user do not need to read and type a challenge value on one device or program and then generate a response and then type that into the first device or program. It is done automatically.

The same implementation of the present solutions can be used on almost all different clients (servers, computers, handheld devices).

With the present invention it is possible to make critical changes to the implementation and release it overnight to end customers by changing a web page. The current solutions according to the prior art will often take months to change.

The present solutions do not need to be distributed from a server or administrated by an administrator.

The present solutions are self serviced. The user can manage and disable tokens themselves. They will also notice by themselves if a security breach has occurred.

The present solutions cannot be lost.

The present solution will not be off sync as some synchronized methods can become. If it does, users can re-sync it by themselves.

The solution according to the present invention is your soft token. You do not have to bring anything else with you.

No client installation is needed at all. Everybody already have what we need to install.

The present solutions will work on any thin client. It makes use of i. e. well known standards and techniques. But it uses them in a totally new way, resulting in all of the benefits described above.

Furthermore, a synchronized variable could be used together with the solutions according to the present invention. This will add the security of a synchronized method with the ease to use the present solution. The variable is synchronized between the client and the server and can be used when calculating the response.

The invention is not limited to the described embodiments. It will be evident for those skilled in the art that many different modifications are feasible within the scope of the following Claims.

1. A system operable to perform two factor authentication, characterized in that said system comprises a browser means, a server means connected to said browser means, and a memory means connected to said browser means, wherein said server means is operable to receive a first factor from a user means, and thereafter to automatically send a two factor challenge to said browser means, where after said browser means is operable to automatically retrieve an encrypted secret from said memory means, and to automatically decrypt said secret, wherein said two factor authentication is based on said challenge and said decrypted secret.

2. A system operable to perform two factor authentication according to claim 1, characterized in that said browser means also is operable to automatically calculate a response based on said challenge and said decrypted secret, and to automatically send said response to said server means, which in turn is operable to automatically authenticate the user if said response is a match, and to automatically reject the authentication if said response does not match.

3. A system operable to perform two factor authentication according to claim 2, characterized in that, if said response does not match, said server means is operable to delete said secret.

4. A system operable to perform two factor authentication according to claim 3, characterized in that, when said secret have been deleted, or when none exists, said system is operable to store a new secret in said memory means.

5. A system operable to perform two factor authentication according to claim 1, characterized in that said memory means is in the form of a local, permanent memory means in said browser means.

6. A system operable to perform two factor authentication according to claim 1, characterized in that said secret is encrypted by using information from said browser means, device specific information, and username and password, or other information only known by the user.

7. A method for performing two factor authentication with the aid of a system comprising a browser means, a server means connected to said browser means, and a memory means connected to said browser means, wherein said method comprises the steps:
with the aid of said server means, to receive a first factor from a user means;
with the aid of said server means, to automatically send a two factor challenge to said browser means;
with the aid of said browser means, to automatically retrieve an encrypted secret from said memory means;
with the aid of said browser means, to automatically decrypt said secret; and
to automatically perform two factor authentication based on said challenge and said decrypted secret.

8. A method for performing two factor authentication according to claim 7, characterized in that said method also comprises the steps:
with the aid of said browser means, to automatically calculate a response based on said challenge and said decrypted secret;
with the aid of said browser means, to automatically send said response to said server means; and
with the aid of said server means, to automatically authenticate the user if said response is a match; or to automatically reject the authentication if said response does not match.

9. A method for performing two factor authentication according to claim 8, characterized in that said method also comprises the step:
if said response does not match, with the aid of said server means, to delete said secret.

10. A method for performing two factor authentication according to claim 9, characterized in that said method also comprises the step:
with the aid of said system, to store a new secret in said memory means, when said secret have been deleted, or when none exists.

11. A method for performing two factor authentication according to claim 7, characterized in that said memory means is in the form of a local, permanent memory means in said browser means.

12. A method for performing two factor authentication according to claim 7, characterized in that said secret is encrypted by using information from said browser means, device specific information, and username and password, or other information only known by the user.

13. A system operable to perform digital signing, characterized in that said system comprises a browser means, a server means connected to said browser means, and a memory means connected to said browser means, wherein said server means is operable to automatically send a signing challenge to said browser means, where after said browser means is operable to automatically retrieve an encrypted secret from said memory means, and to automatically decrypt said secret, wherein said digital signing is based on said signing challenge and said decrypted secret.

14. A system operable to perform digital signing according to claim 13, characterized in that said browser means also is operable to receive a security PIN code from a user means, to automatically calculate a signing response based on said signing challenge, said security PIN code, and said decrypted secret, and to automatically send said signing response to said server means, where after said server means is operable to automatically perform said digital signing, if said signing response is a match, or to automatically reject said digital signing if said signing response does not match.

15. A system operable to perform digital signing according to claim 13, characterized in that said server means also is operable to first receive something the user knows from a user means, and then to sign digitally.

16. A system operable to perform digital signing according to claim 15, characterized in that said browser means also is operable to automatically calculate a signing response based on said signing challenge and said decrypted secret, and to automatically send said signing response to said server means, which in turn is operable to automatically perform said digital signing, if said signing response is a match, or to automatically reject said digital signing if said signing response does not match.

17. A system operable to perform digital signing according to claim 14, characterized in that, if said signing response does not match, said server means is operable to delete said secret.

18. A system operable to perform digital signing according to claim 17, characterized in that, when said secret have been deleted, or when none exists, said system is operable to store a new secret in said memory means.

19. A system operable to perform digital signing according to claim 13, characterized in that said memory means is in the form of a local, permanent memory means in said browser means.

20. A system operable to perform digital signing according to claim 13, characterized in that said secret is encrypted by using information from said browser means, device specific information, and username and password, or other information only known by the user.

21. A method for performing digital signing with the aid of a system comprising a browser means, a server means connected to said browser means, and a memory means-connected to said browser means, wherein said method comprises the steps:
with the aid of said server means, to automatically send a signing challenge to said browser means;
with the aid of said browser means, to automatically retrieve an encrypted secret from said memory means;
with the aid of said browser means to automatically decrypt said secret; and
to automatically perform digital signing based on said signing challenge and said decrypted secret.

22. A method for performing digital signing according to claim 21, characterized in that said method also comprises the steps:
with the aid of said browser means, to receive a security PIN code from a user means;
with the aid of said browser means, to automatically calculate a signing response based on said signing challenge, said security PIN code, and said decrypted secret;
with the aid of said browser means, to automatically send said signing response to said server means; and
with the aid of said server means, to automatically perform digital signing, if said signing response is a match; or to automatically reject said digital signing if said signing response does not match.

23. A method for performing digital signing according to claim 21, characterized in that said method also comprises the step:
with the aid of said server means, to first receive something the user knows from a user means, and then to sign digitally.

24. A method for performing digital signing according to claim 23, characterized in that said method also comprises the steps:
with the aid of said browser means, to automatically calculate a signing response based on said signing challenge and said decrypted secret;
with the aid of said browser means, to automatically send said signing response to said server means; and
with the aid of said server means, to automatically perform digital signing, if said signing response is a match; or to automatically reject said digital signing if said signing response does not match.

25. A method for performing digital signing according to claim 22, characterized in that said method also comprises the step:
if said signing response does not match, with the aid of said server means, to delete said secret.

26. A method for performing digital signing according to claim 25, characterized in that said method also comprises the step:
with the aid of said system, to store a new secret in said memory means, when said secret have been deleted, or when none exists.

27. A method for performing digital signing according to claim 21, characterized in that said memory means is in the form of a local, permanent memory means in said browser means.

28. A method for performing digital signing according to claim 21, characterized in that said secret is encrypted by using information from said browser means, device specific information, and username and password, or other information only known by the user.

29. At least one computer program product (102₁, . . . , 102ₙ) directly loadable into the internal memory of at least one digital computer (100₁, 100ₙ), comprising software code portions for performing the steps of claim 7 when said at least one product (102₁, . . . , 102ₙ) is/are run on said at least one computer (100₁, . . . , 100ₙ).
